(19) United States
(12) Patent Application Publication
(10) Pub. No.: US 2025/0383612 A1
(43) Pub. Date: Dec. 18, 2025

(54) Toner

(71) Applicant: CANON KABUSHIKI KAISHA, Tokyo (JP)

(72) Inventors: NAOYA ISONO, Shizuoka (JP); KANARU AKIMOTO, Hyogo (JP); KENTARO YAMAWAKI, Shizuoka (JP); KOKI INOUE, Shizuoka (JP)

(21) Appl. No.: 19/235,458

(22) Filed: Jun. 11, 2025

(30) Foreign Application Priority Data
Jun. 18, 2024 (JP) 2024-097874

(51) Int. Cl. G03G 9/09; G03G 9/087

(52) U.S. Cl. CPC G03G 9/0904; G03G 9/08711

(57) ABSTRACT

A toner includes a toner particle containing a binder resin, a pigment, and a pigment dispersant. The pigment dispersant comprises a structure represented by formula (1) and a structure represented by formula (2):

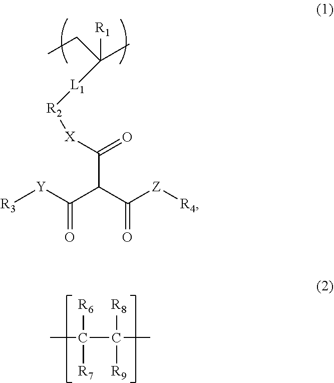

where R₁-R₄, R₆-R₉, L₁, X, Y, and Z are substitutents.

### BACKGROUND

### Technical Field

The present disclosure relates to a toner used for developing electrostatic latent images formed by electrophotography, electrostatic recording, toner jet recording, or other similar methods to form toner images.

### Description of the Related Art

The demands of users for electrophotographic technology used in copy machines, printers, facsimile receivers, and the like are becoming stricter year by year as such apparatuses advance. A recent trend is a strong demand for compact designs that can be installed anywhere.

One approach to such a demand is to improve the tinting strength of toner so that images can be formed using a smaller amount of toner, thereby reducing the size of the toner container.

Finely dispersing pigment is effective in improving the tinting strength of toner. For example, Japanese Patent Laid-Open No. 2017-049404 discloses a toner as a measure to improve the dispersibility of pigment. The toner contains a pigment dispersant having a site adsorbable to pigment and a polymeric site compatible with the dispersion medium for the pigment, and a polar resin with an acid value in a specific range.

This measure gives toners high tinting strength and excellent durability and enables the downsizing of the toner container.

However, image formation with a still smaller amount of toner is demanded from the viewpoint of further reducing the container size. The pigment dispersant disclosed in Japanese Patent Laid-Open No. 2017-049404 has a limited effect in inhibiting the aggregation of pigment, and further improvement in tinting strength cannot be expected. Accordingly, there is still a demand for improvement in the tinting strength of toner by increasing the dispersibility of pigment.

### SUMMARY

The present disclosure provides a toner with excellent tinting strength that inhibits the pigment in the toner from aggregating.

The toner includes a toner particle containing a binder resin, a pigment, and a pigment dispersant, the pigment dispersant comprising a structure represented by formula (1) and a structure represented by formula (2):

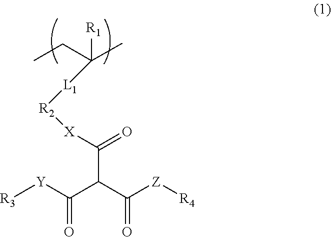

wherein in equation (1),
X, Y, and Z each independently represent —O—, a methylene group, or —NR₅—,
R₅ represents a hydrogen atom or an alkyl group with 1 to 4 carbon atoms,
L₁ represents an ester bond or an amide bond,
R₁ represents a hydrogen atom or a methyl group,
R₂ represents an alkylene group with 2 to 4 carbon atoms,
R₄ represents a substituted or unsubstituted phenyl group, a substituted or unsubstituted polycyclic aromatic group, or a substituted or unsubstituted heterocyclic group, and
R₃ represents a hydrogen atom, a substituted or unsubstituted phenyl group, an aralkyl group, a substituted or unsubstituted alkyl group with 1 to 18 carbon atoms, or a monovalent group formed by substituting —O—, —COO—, or —CONH— for a methylene group of an alkyl group with 2 to 18 carbon atoms.

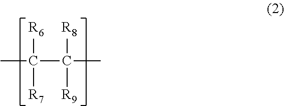

wherein in equation (2),
at least two of R₆ to R₉ represent —V—COOR₁₀ and the others each independently represent a hydrogen atom or an alkyl group with 1 to 4 carbon atoms,
V represents a single bond or an alkylene group with 1 or 2 carbon atoms, and
R₁₀ represents an alkyl group with 16 to 30 carbon atoms.

Further features of the present disclosure will become apparent from the following description of exemplary embodiments.

### DESCRIPTION OF THE EMBODIMENTS

The present disclosure will now be described in detail but can be implemented without being limited to the following embodiments. In the description provided herein, the expressions representing numerical ranges, such as “XX or more and YY or less” and “XX to YY”, refer to ranges including the lower and upper limits that are the endpoints, unless otherwise noted. When some numerical ranges are presented in steps, the lower and upper limits of the respective ranges may be combined as desired. A monomer unit refers to a structure formed by a reaction of a monomer in a polymer.

The requirements mentioned above will now be described in detail.

The toner disclosed herein includes: a toner particle containing a binder resin, a pigment, and a pigment dispersant, the pigment dispersant comprising a structure represented by formula (1) and a structure represented by formula (2):

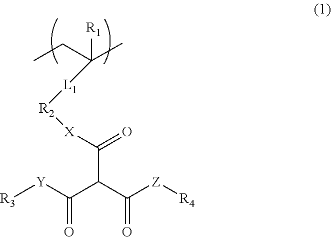

wherein in formula (1),
X, Y, and Z each independently represent —O—, a methylene group, or —NR₅—,
R₅ represents a hydrogen atom or an alkyl group with 1 to 4 carbon atoms,
L₁ represents an ester bond or an amide bond,
R₁ represents a hydrogen atom or a methyl group,
R₂ represents an alkylene group with 2 to 4 carbon atoms,
R₄ represents a substituted or unsubstituted phenyl group, a substituted or unsubstituted polycyclic aromatic group, or a substituted or unsubstituted heterocyclic group, and
R₃ represents a hydrogen atom, a substituted or unsubstituted phenyl group, an aralkyl group, a substituted or unsubstituted alkyl group with 1 to 18 carbon atoms, or a monovalent group formed by substituting —O—, —COO—, or —CONH— for a methylene group of an alkyl group with 2 to 18 carbon atoms.

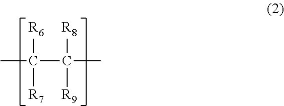

wherein in formula (2),
at least two of R₆ to R₉ represent —V—COOR₁₀ and the others each independently represent a hydrogen atom or an alkyl group with 1 to 4 carbon atoms,
V represents a single bond or an alkylene group with 1 or 2 carbon atoms, and
R₁₀ represents an alkyl group with 16 to 30 carbon atoms.

The toner satisfying the above requirements can exhibit excellent tinting strength. The present inventors believe that the mechanism of this achievement is as follows.

The pigment dispersant disclosed herein is a polymer having a structure represented by formula (1) and a structure represented by formula (2):

The structure represented by formula (1) has a site exhibiting strong 71-71 interactivity and, therefore, easily interacts strongly with the pigment. Thus, the polymer containing the structure represented by formula (1) can be present close to the pigment.

The structure represented by formula (2) has at least two long-chain alkyl groups, and the long-chain alkyl groups in the structure are close to each other. These close long-chain alkyl groups are likely to cause steric hindrance repulsion. Therefore, the polymer containing the structure represented by formula (2) can improve the dispersion stability of the pigment because of rejection by the steric hindrance repulsion.

The use of the pigment dispersant disclosed herein inhibits the pigment aggregation to stabilize the dispersion of the pigment, leading to a toner with excellent tinting strength.

### Pigment Dispersant

Details and desirable conditions of the structure represented by formula (1) in the pigment dispersant will now be described.

The structure represented by formula (1) in the pigment dispersant acts as the site that adsorbs to the pigment and is called the adsorbing site.

In formula (1), R₄ is involved in the π-π interaction with the pigment. Therefore, R₄ must have a structure with a π-planarity. Specifically, groups that can be R₄ include substituted or unsubstituted phenyl groups, substituted or unsubstituted polycyclic aromatic groups, and substituted or unsubstituted heterocyclic groups. Substituted or unsubstituted polycyclic aromatic groups and substituted or unsubstituted heterocyclic groups exhibit strong π-π interactivity and are thus beneficial. R₄ having a benzimidazolinone structure is more beneficial. The benzimidazolinone structure has high planarity and a strong ability to bind with hydrogen and is therefore highly adsorptive to the pigment, improving the tinting strength of the toner. Possible substituents include, for example, a halogen atom and nitro, amino, hydroxy, cyano, and trifluoromethyl groups.

R₃ in formula (1) may incorporate a compound with a π-planarity to compensate for the adsorption of the pigment dispersant to the pigment or a structure, such as an alkyl group, that adjusts the solubility in the dispersion medium. The compound or structure to be incorporated is desirably not bulky to avoid inhibiting adsorption to the pigment. Specifically, R₃ represents a hydrogen atom, a substituted or unsubstituted phenyl group, an aralkyl group, a substituted or unsubstituted alkyl group with 1 to 18 carbon atoms, or a monovalent group formed by substituting —O—, —COO—, or —CONH— for a methylene group of an alkyl group with 2 to 18 carbon atoms. Possible substituents include, for example, a halogen atom and nitro, amino, hydroxy, cyano, and trifluoromethyl groups. Beneficially, R₃ is an alkyl group with 1 to 12 carbon atoms or a phenyl group. An alkyl group with 2 to 12 carbon atoms, for example, with 2 to 8 carbon atoms, is more beneficial. R₃ having such a structure enables the pigment dispersant to maintain its adsorptive performance to the pigment. Consequently, the toner is likely to exhibit excellent tinting strength. The alkyl group may be linear, branched, or cyclic. When an alkyl group is substituted, the number of carbons includes the number of carbons in the substituent.

R₂ in formula (1) is a divalent functional group and is an alkylene group with 2 to 4 carbon atoms. When R₂ is an alkylene group with 2 to 4 carbon atoms, the adsorbing site has good solubility and is accordingly less likely to aggregate. Consequently, the tinting strength of the toner is likely to increase.

R₁ in formula (1) represents a hydrogen atom or a methyl group.

X, Y, and Z in formula (1) each independently represent —O—, a methylene group, or —NR₅—. R₅ represents a hydrogen atom or an alkyl group with 1 to 4 carbon atoms. The alkyl group may be linear, branched, or cyclic. At least two of X, Y, and Z may be —NH—.

In this instance, the structural stability of the compound is improved. Beneficially, both X and Z are —NH—. This is because —NH— as Z forms an amide bond, which is advantageous for adsorption to the pigment. Also, —NH— as X is beneficial in the production process. Y may be —O— from the viewpoint of easily diversifying the structure of R₃.

L₁ in formula (1) is a linkage to the polymer portion and is an ester bond or an amide bond from the viewpoint of ease of production.

Thus, the adsorbing site of the pigment dispersant disclosed herein may have the structure represented by formula (3).

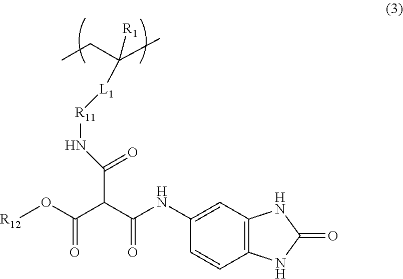

wherein in formula (3),
L₁ represents an ester bond or an amide bond,
R₁ represents a hydrogen atom or a methyl group,
R₁₁ represents an alkylene group with 2 to 4 carbon atoms,
R₁₂ represents a hydrogen atom, a substituted or unsubstituted phenyl group, an aralkyl group, a substituted or unsubstituted alkyl group with 1 to 18 carbon atoms, or a monovalent group formed by substituting —O—, —COO—, or —CONH— for a methylene group of an alkyl group with 2 to 18 carbon atoms.

The pigment dispersant having the structure represented by formula (3) as the adsorbing site exhibits enhanced adsorptive performance to the pigment. Consequently, the toner is likely to exhibit excellent tinting strength.

The amount of the structure represented by formula (1) in the pigment dispersant may be 1.0 mass % to 15.0 mass %. When the amount of the structure represented by formula (1) is 1.0 mass % or more, the proportion of the site of the pigment dispersant that interacts with the pigment increases, thus allowing the pigment dispersant to be close to the pigment. Consequently, the tinting strength of the toner is likely to increase. When the amount of the structure represented by formula (1) is 15.0 mass % or less, the length of the polymeric chain of the polymer portion (also called the loop length) between the structures represented by formula (1) is sufficient to create steric hindrance, thus easily inhibiting the pigment aggregation. Consequently, the tinting strength of the toner is likely to increase.

Next, the structure represented by formula (2) in the pigment dispersant will be described.

At least two of R₆ to R₉ in formula (2) represent —V—COOR₁₀, wherein V represents a single bond or an alkylene group with 1 or 2 carbon atoms, and R₁₀ represents an alkyl group with 16 to 30 carbon atoms. The others each independently represent a hydrogen atom or an alkyl group with 1 to 4 carbon atoms. As described above, close long-chain alkyl groups cause steric hindrance repulsion, thus imparting a necessary rejection effect to the pigment dispersant. When R₁₀ has 16 or more carbon atoms, the pigment dispersant exhibits sufficient steric hindrance repulsion, leading to a toner with excellent tinting strength. Also, the transition temperature Tg of the pigment dispersant increases, leading to improved storage stability of the toner. R₁₀ with 30 or less carbon atoms does not interfere with the interaction between the structure of formula (1) and the pigment and allows the pigment dispersant to be close to the pigment, leading to a toner with excellent tinting strength. The number of carbons of R₁₀ is preferably 18 to 28 and more preferably 20 to 24.

To introduce the structure represented by formula (2) to the pigment dispersant, a polymerizable ester produced by condensation of a polyvalent carboxylic acid with a structure represented by formula (2′) and long-chain alkyl monoalcohol with 16 to 30 carbon atoms (hereinafter referred to as the polymerizable ester disclosed herein) may be used as a polymerizable monomer.

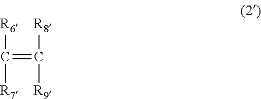

wherein in equation (2′),
at least two of R_{6′} to R_{9′} represent —V—COOH and the others each independently represent a hydrogen atom or an alkyl group with 1 to 4 carbon atoms, and
V represents a single bond or an alkylene group with 1 or 2 carbon atoms.

Polyvalent carboxylic acids represented by formula (2′) include maleic acid, fumaric acid, citraconic acid, mesaconic acid, itaconic acid, glutaconic acid, trans-aconitic acid, and cis-aconitic acid. These polyvalent carboxylic acids may be in the form of acid anhydrides or lower alkyl esters (with 1 to 4 carbon atoms), such as methyl esters, ethyl esters, and isopropyl esters. Polyvalent carboxylic acids may be used individually or in combination. Maleic acid, fumaric acid, itaconic acid, and their anhydrides are beneficial in producing advantageous effects in the present disclosure.

Examples of the long-chain alkyl monoalcohol with 16 to 30 carbon atoms include cetanol, stearyl alcohol, 1-eicosanol, behenyl alcohol, 1-tetracosanol, and 1-triacontanol.

The process for producing the polymerizable ester disclosed herein uses a polyvalent carboxylic acid represented by formula (2′) and a long-chain alkyl monoalcohol with 16 to 30 carbon atoms and is otherwise not limited. To ensure the condensation reaction and inhibit the reaction of the carbon-carbon double bond, an esterification catalyst and a stabilizer (polymerization inhibitor) may be used.

The amount of the structure represented by formula (2) in the pigment dispersant may be 5.0 mass % to 70.0 mass %. When the amount of the structure represented by formula (2) is 5.0 mass % or more, the close long-chain alkyl groups cause steric hindrance repulsion to produce a rejection effect. Consequently, the toner exhibits good tinting strength and reduced color unevenness. When the amount of the structure represented by formula (2) is 70.0 mass % or less, the structure does not interfere with the interaction with the pigment and allows the pigment dispersant to be close to the pigment. Consequently, the tinting strength of the toner is likely to increase. More preferably, the amount of the structure represented by formula (2) is 10.0 mass % to 60.0 mass %.

The pigment dispersant may contain a monomer unit derived from any of the following monomers in addition to the above-described structures represented by formula (1) and formula (2).

Such monomers include styrene and styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; polymerizable acrylic monomers, such as acrylic acid, methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, n-lauryl acrylate, cyclohexyl acrylate, 2-methoxyethyl acrylate, benzyl acrylate, dimethyl phosphate ethyl acrylate, diethyl phosphate ethyl acrylate, dibutyl phosphate ethyl acrylate, and 2-benzoyloxyethyl acrylate; and polymerizable methacrylic monomers, such as methacrylic acid, methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, 2-methoxyethyl methacrylate, diethyl phosphate ethyl methacrylate, and dibutyl phosphate ethyl methacrylate; and acrylonitril and methacrylonitrile.

The weight average molecular weight (Mw) of the pigment dispersant may be 10000 to 50000. Preferably, it is 15000 to 40000.

### Production Process of Pigment Dispersant

The process for producing the pigment dispersant will now be described. The pigment dispersant can be produced by copolymerizing the polymerizable ester disclosed herein and a compound with an adsorbing site incorporating a polymerizable group.

Alternatively, the pigment dispersant can be produced by adding an intermediate of the adsorbing site to a resin containing the structure represented by formula (2) and a functional group that can react with the intermediate of the adsorbing site. Either process can use a known synthesis or polymerization method. For example, the following scheme can be used for the synthesis.

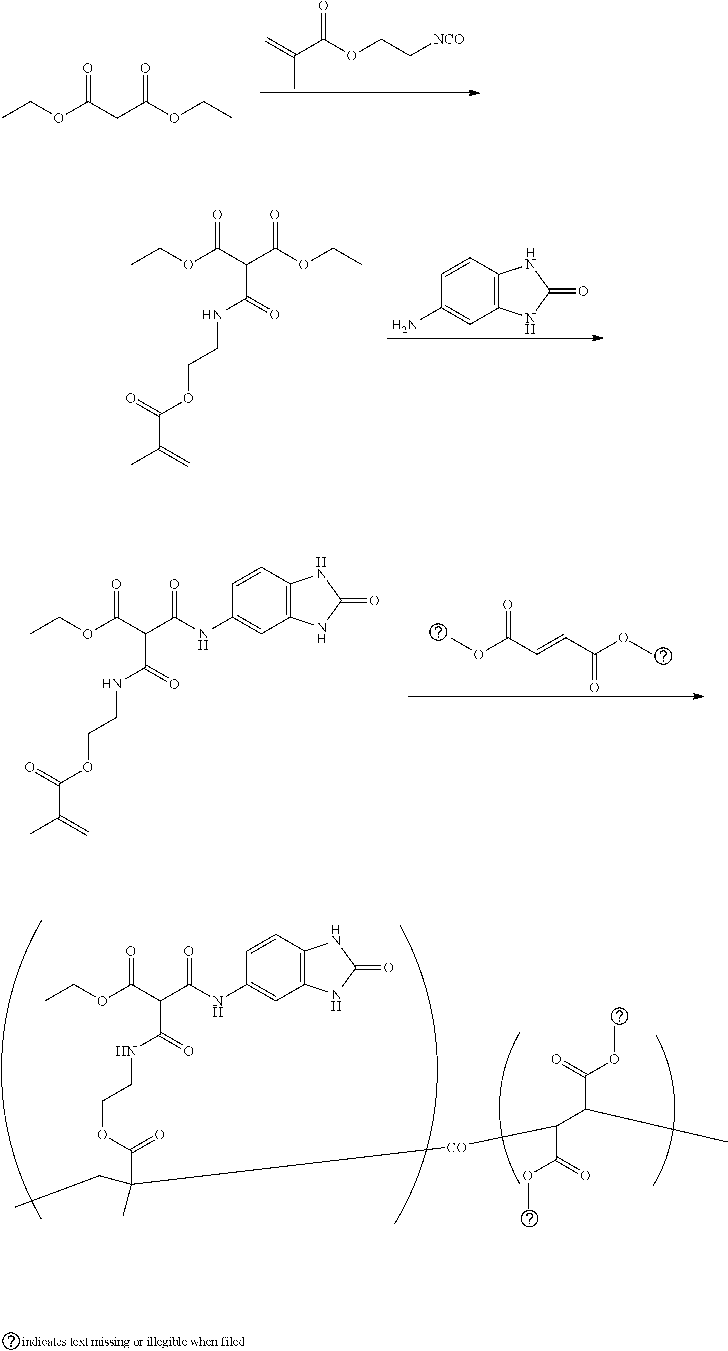

Wherein in this scheme, “-co-” represents copolymerization.

In the above scheme, the adsorbing site incorporating a polymerizable functional group can polymerize with the polymerizable ester disclosed herein through a known process, such as radical polymerization, living radical polymerization, anionic polymerization, or cationic polymerization, to produce the pigment dispersion. The structures of formula (1) and formula (2) in the pigment dispersant may be present in a random or block state.

The temperature and time for the reaction in each step, the solvent and catalyst used, and the purification method after synthesis can be determined as appropriate for the target product. The molecular structure of the synthesized adsorbing site and the physical properties of the polymerized pigment dispersant can be identified with a nuclear magnetic resonator (NMR), an infrared spectrophotometer (IR), a mass spectrometer (MS), a gel permeation chromatograph (GPC), or the like.

If an intermediate of the adsorbing site is added to a previously polymerized resin, the resin before the addition is required to have a functional group to which the intermediate can be added. For this purpose, known methods can be used.

### Pigment

The pigment may be selected from the following: carbon black; C.I. Pigment Yellow 74, 93, 139, 155, 180, and 185; C.I. Pigment Red 31, 122, 150, 170, 185, 258, and 269; and C.I. Pigment Blue 15:3 and 15:4.

When these pigments are used, the π-π interaction and the effect of the hydrogen bond of the pigment dispersant function strongly for adsorption. Consequently, the pigment dispersant is likely to be present close to the pigment, exhibiting increased pigment dispersibility.

Beneficially, the pigment is selected from carbon black; C.I. Pigment Yellow 74, 93, 155, 180, and 185; C.I. Pigment Red 122 and 150; and C.I. Pigment Blue 15:3.

The amount of the pigment dispersant in the toner particle may be 1.5 mass % to 30.0 mass % relative to the total mass of the pigment from the viewpoint of the tinting strength and color unevenness. Preferably, it is 5.0 mass % to 25.0 mass %, more preferably 10.0 mass % to 20.0 mass %.

### Crystalline Material

The toner particle may contain a crystalline material from the viewpoint of low-temperature fixability. Crystalline materials refer to those exhibiting an endothermic peak in differential scanning calorimetry (DSC), such as wax and crystalline resin.

The crystalline material content of the toner particle may be 20.0 mass % to 50.0 mass % from the viewpoint of low-temperature fixability. The crystalline material in the toner particle melts once during fixing and then becomes likely to form domains through crystal growth when cooled to solidify. If the toner particle contains a large amount of crystalline material, the domains of the crystalline material in the toner layer after fixing cause irregular reflection, easily leading to color unevenness in the resulting images. When the pigment dispersant disclosed herein and a crystalline material are contained in the toner particle, the long-chain alkyl groups in the structure represented by formula (2) act as a nucleating agent for the crystalline material. Since the pigment dispersant is finely dispersed in each toner particle, the pigment dispersant can inhibit the crystal growth of the crystalline material to reduce the formation of domains. Consequently, irregular reflection from the image does not occur, and thus, color unevenness can be reduced.

Examples of the crystalline material include waxes, such as hydrocarbon-based wax and ester wax, and crystalline resins, such as crystalline vinyl resin, crystalline polyester, crystalline polyurethane, and crystalline epoxy resin. Among these, crystalline vinyl resin and crystalline polyester are beneficial. Crystallize vinyl resin is more beneficial.

The crystalline vinyl resin used as the crystalline resin may have the structure represented by formula (4) or (5).

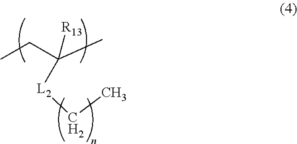

wherein in formula (4),
R₁₃ represents a hydrogen atom or a methyl group,
L₂ represents a single bond, —COO—, or —CONH—, and
n represents an integer of 15 to 30.

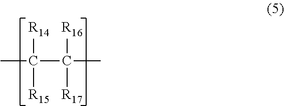

wherein in formula (5),
at least two of R₁₄ to R₁₇ represent —W—COOR₁₈ and the others each represent a hydrogen atom or an alkyl group with 1 to 4 carbon atoms,
W represents a single bond or an alkylene group with 1 or 2 carbon atoms, and
R₁₈ represents an alkyl group with 16 to 30 carbon atoms.

Crystalline vinyl resin having such a structure is likely to form a crystalline side chain structure, consequently helping the toner exhibit a sharp melting property and improved low-temperature fixability. Also, the crystalline side chain structure has higher crystallinity than crystalline folded main chain structures and, accordingly, can impart higher durability and storage stability to the toner. In formula (4), n may be an integer of 17 to 29, preferably 19 to 23. In formula (5), R₁₈ may be an alkyl group with 18 to 28 carbon atoms, for example, an alkyl group with 20 to 24 carbon atoms.

The crystalline vinyl resin may have a monomer unit derived from other polymerizable monomers in addition to the above structures.

Examples of other polymerizable monomers include: styrene and styrene derivatives, such as a-methylstyrene, P-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; polymerizable acrylic monomers, such as acrylic acid, methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, n-lauryl acrylate, cyclohexyl acrylate, 2-methoxyethyl acrylate, benzyl acrylate, dimethyl phosphate ethyl acrylate, diethyl phosphate ethyl acrylate, dibutyl phosphate ethyl acrylate, 2-benzoyloxyethyl acrylate, and acrylonitrile; and polymerizable methacrylic monomers, such as methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, 2-methoxyethyl methacrylate, diethyl phosphate ethyl methacrylate, and dibutyl phosphate ethyl methacrylate, and methacrylonitrile.

Among such polymerizable monomers, styrene, methacrylic acid, acrylic acid, methyl (meth)acrylate, acrylonitrile, and methacrylonitrile are beneficial.

The crystalline vinyl resin has a different structure from the pigment dispersant and does not contain the structure represented by formula (1).

If wax is used as the crystalline material, the type of wax is not limited, but hydrocarbon-based wax or ester wax is suitably used.

Examples of hydrocarbon-based wax include: low-molecular-weight polyethylene, low-molecular-weight polypropylene, low-molecular-weight olefin copolymers, Fischer-Tropsch wax, paraffin wax, and waxes produced by oxidizing these waxes or adding acid to these waxes.

Ester wax may be natural ester wax or synthesized ester wax as long as it contains at least one ester bond in the molecule.

Examples of ester wax include: esters of a monohydric alcohol and a monocarboxylic acid, such as behenyl behenate, stearyl stearate, and palmityl palmitate; esters of a divalent carboxylic acid and a monoalcohol, such as dibehenyl sebacate; esters of a dihydric alcohol and a monocarboxylic acid, such as ethylene glycol distearate and hexanediol dibehenate; esters of a trihydric alcohol and a monocarboxylic acid, such as glycerol tribehenate; esters of a tetrahydric alcohol and a monocarboxylic acid, such as pentaerythritol tetrastearate and pentaerythritol tetrapalmitate; esters of a hexahydric alcohol and a monocarboxylic acid, such as dipentaerythritol hexastearate, dipentaerythritol hexapalmitate, and dipentaerythritol hexabehenate; and esters of a polyfunctional alcohol and a monocarboxylic acid, such as polyglycerol behenate; and natural waxes, such as carnauba wax and rice wax.

### Production Method of Toner Particle

The toner particle according to the present disclosure can be produced by any method and may be produced, for example, in a process of forming particles in an aqueous medium, such as suspension polymerization, emulsion aggregation, or suspension granulation.

The following describes a method using suspension polymerization, which is most suitable for producing the toner particle disclosed herein.

The pigment dispersant, a pigment, a crystalline material, and wax and also polymerizable monomers that form a binder resin and other optional additives are uniformly dissolved or dispersed as needed with a disperser, such as a homogenizer, a ball mill, a colloid mill, or an ultrasonic disperser. A polymerization initiator is added to the resulting solution or dispersion to prepare a polymerizable monomer composition.

Then, the polymerizable monomer composition is suspended in an aqueous medium containing a dispersion stabilizer for polymerization of the polymerizable monomers, thus producing toner particle.

Examples of monofunctional polymerizable monomers include styrene and styrene derivatives, such as a-methylstyrene, P-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
polymerizable acrylic monomers, such as methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; and polymerizable methacrylic monomers, such as methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate.

Examples of polyfunctional polymerizable monomers include diethylene glycol diacrylate, triethylene glycol diacrylate, tetraethylene glycol diacrylate, ploypropylene diacrylate, 1,6-hexanediol diacrylate, neopentyl glycol diacrylate, tripropylene glycol diacrylate, polypropylene glycol diacrylate, 2,2′-bis(4-(acryloxy diethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy diethoxy)phenyl)propane, 2,2′-bis(4-(methacryloxy polyethoxy)phenyl)propane, trimethylolpropane trimethacrylate, tetramethylolmethane tetramethacrylate, tetramethylolmethane tetramethacrylate, divinylbenzene, divinylnaphthalene, and divinyl ether.

Such polymerizable monomers may be used individually or in combination.

The polymerization initiator may be added simultaneously when other additives are added to the polymerizable monomers or immediately before being suspended in the aqueous medium. Alternatively, the polymerization initiator may be dissolved in a polymerizable monomer or a solvent and added immediately after particle formation and before starting the polymerization reaction.

The polymerization initiator may be organic peroxide-based or azo-based.

Examples of organic peroxide-based initiators include: benzoyl peroxide, lauroyl peroxide, di-α-cumyl peroxide, 2,5-dimethyl-2,5-bis(benzoylperoxy)hexane, bis(4-t-butylcyclohexyl) peroxydicarbonate, 1,1-bis(t-butylperoxy)cyclododecane, t-butylperoxymaleic acid, bis(t-butylperoxy) isophthalate, methyl ethyl ketone peroxide, tert-butylperoxy-2-ethylhexanoate, diisopropyl peroxycarbonate, cumene hydroperoxide, 2,4-dichlorobenzoyl peroxide, and tert-butyl peroxypivalate.

Examples of azo-based polymerization initiators include 2,2′-azobis-(2,4-dimethylvaleronitrile), 2,2′-azobis(isobutyronitrile), 1,1′-azobis(cyclohexane-1-carbonitrile), 2,2′-azobis(4-methoxy-2,4-dimethylvaleronitrile) and azobis(methylbutyronitrile).

Also, a redox initiator that is a combination of oxidizing and reducing substances may be used as the polymerization initiator. Oxidizing substances include inorganic peroxides, such as hydrogen peroxide, persulfates (sodium, potassium, and ammonium salts), and oxidizing metal salts, such as tetravalent cerium salts. Reducing substances include reducing metal salts (divalent iron salts, monovalent copper salts, and trivalent chromium salts); amino compounds, such as ammonia, lower amines (methylamine, ethylamine, and other amines with about 1 to 6 carbon atoms), and hydroxylamine; reducing sulfur compounds, such as sodium thiosulfate, sodium hydrosulfate, sodium hydrogen sulfite, sodium sulfite, and sodium formaldehydesulfoxylate; lower alcohols (with 1 to 6 carbon atoms); ascorbic acid and its salts; and lower aldehydes (with 1 to 6 carbon atoms).

The polymerization initiator is selected with reference to the 10-hour half-life temperature and may be used alone or in a mixture. The amount of the polymerization initiator varies depending on the intended degree of polymerization, and in general, 0.5 part to 20.0 parts by mass is added relative to 100.0 parts by mass of polymerizable monomers.

A known chain transfer agent and polymerization inhibitor may further be added to control the polymerization degree.

For polymerization of polymerizable monomers, various crosslinking agents may be used. Such crosslinking agents include polyfunctional compounds, such as divinylbenzene, 4,4′-divinylbiphenyl, ethylene glycol diacrylate, ethylene glycol dimethacrylate, diethylene glycol diacrylate, diethylene glycol dimethacrylate, glycidyl acrylate, glycidyl methacrylate, trimethylolpropane triacrylate, and trimethylolpropane trimethacrylate.

The pigment may be used in a proportion of 1.0 part to 20.0 parts by mass relative to 100.0 parts by mass of the binder resin.

The dispersion stabilizer used when the aqueous medium is prepared can be selected from among known inorganic and organic dispersion stabilizers. Examples of inorganic dispersion stabilizers include tricalcium phosphate, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silica, and alumina. Examples of organic dispersion stabilizers include polyvinyl alcohol, gelatin, methyl cellulose, methyl hydroxypropyl cellulose, ethyl cellulose, carboxymethyl cellulose sodium salt, polyacrylic acid and its salts, and starch. The amount of such a dispersion stabilizer used may be 0.2 part to 20.0 parts by mass relative to 100.0 parts by mass of polymerizable monomers.

When an inorganic dispersion stabilizer is used, a commercially available product may be used as it is, or still finer particles of the inorganic dispersion stabilizer may be formed in an aqueous medium. For example, tricalcium phosphate can be produced by mixing a sodium phosphate aqueous solution and a calcium chloride aqueous solution with high-speed stirring.

The toner disclosed herein may include an external additive present on the surface of the toner particle to improve image quality. The external additive may be an organic or inorganic fine powder, but inorganic powder such as silica fine powder, titanium oxide fine powder, or aluminum oxide fine powder may be suitable.

Such inorganic fine powder may be hydrophobized with a hydrophobizing agent, such as a silane coupling agent, silicone oil, or their mixture.

The amount of the inorganic fine powder added may be 1.0 part to 5.0 parts by mass relative to 100.0 parts by mass of the toner particle (base particle before adding the external additive).

Measurement methods for physical properties discussed herein will now be described.

### Composition Analysis

The structures of the pigment dispersant and the crystalline material were identified using the following apparatuses:

### ¹H-NMR:

ECA-400 manufactured by JEOL (using deuterated chloroform as solvent)

### ¹³C-NMR:

FT-NMR AVANCE-600 manufactured by Bruker BioSpin (using deuterated chloroform as solvent)

For composition analysis in ¹³C-NMR, quantification was performed by inverse gated decoupling using chromium (III) acetylacetonate as a relaxation regent.

The composition ratio by mole of each monomer unit of the pigment dispersant and crystalline material was calculated, and the composition ratio by mass was determined using the molecular weights of the monomer units.

### Measurement of Molecular Weight

The weight average molecular weights Mw of the toner and the pigment dispersant are measured by gel permeation chromatography (GPC) as described below.

The measurement sample is dissolved in tetrahydrofuran (THF) at room temperature. The resulting solution is filtered through a solvent-resistant membrane filter “Maishori Disk” with a pore size of 0.2 m (manufactured by Tosoh Corporation) to prepare a sample solution. The sample solution is adjusted to a THF-soluble content of 0.8 mass %. The resulting sample solution is measured under the following conditions:

Analyzer: High-performance gel permeation chromatography (GPC) apparatus “HLC-8220GPC” manufactured by Tosoh Corporation
Column: combination of two LF-604 columns, manufactured by Showa Denko
Eluent: THF
Flow rate: 0.6 mL/min
Oven temperature: 40° C.
Sample injection volume: 0.020 mL

For calculating the molecular weight of the sample, a molecular weight calibration curve is prepared using standard polystyrene resins (for example, TSK Standard Polystyrenes F-850, F-450, F-288, F-128, F-80, F-40, F-20, F-10, F-4, F-2, F-1, A-5000, A-2500, A-1000, and A-500, produced by Tosoh Corporation).

### Measurement of Weight Average Particle Size (D4) and Number Average Particle Size (D1) of Toner Particle

An aperture impedance method is applied using a precise particle size distribution analyzer (Coulter counter “Multisizer 3” (trade name)) and a software program (Beckman Coulter Multisizer 3 Version 3. 51 (trade name) supplied from Beckman Coulter). The aperture diameter is 100 m, and the number of effective measurement channels is 25,000.

The measurement data is analyzed and calculated. The aqueous electrolyte solution used for the measurement may be prepared by dissolving highest-quality sodium chloride in ion-exchanged water to a concentration of 1 mass %. Such an electrolyte is available as, for example, ISOTON II (trade name, produced by Beckman Coulter). Before the measurement and analysis, the above-mentioned dedicated software is set up as described below.

On the “standard measurement (SOM) change screen” (translation) of the software, the total count in the control mode is set to 50000 particles; the number of measurements, to 1; and Kd, to the value obtained using “10.0 m standard particles” (produced by Beckman Coulter). On pressing the threshold/noise level measurement button, the threshold and noise level are automatically set. The count is set to 1600 μA; the gain, to 2; and the electrolyte solution, to ISOTON II. A checkmark is placed at the statement “flush of aperture tube after measurement” (translation).

On the “Pulse-to-Particle Size Conversion Setting Screen” (translation) of the dedicated software, the bin distance is set to logarithmic particle size; the particle size bin, to 256 particle size bins; and the particle size range, to a range of 2 m to 60 am.

Specifically, the measurement is performed according to the following procedure.

(1) In a Multisizer-3-specific 250 mL glass round-bottom beaker, 200 mL of the aqueous electrolyte solution is placed and stirred with a stirrer rod counterclockwise at 24 revolutions per second with the beaker set on a sample stand. The dirt and air bubbles in the aperture tube are removed by the “Aperture Flush” function of the software.

(2) In a 100 mL flat bottom glass beaker, 30 mL of the aqueous electrolyte solution is placed. To this electrolyte solution is added 0.3 mL of dilute solution prepared by diluting CONTAMINON N (trade name, 10 mass % aqueous solution of a neutral detergent for precision measurement instruments, produced by Wako Pure Chemical Industries) with ion-exchanged water to three times its mass.

(3) A predetermined volume of ion-exchanged water and 2 mL of CONTAMINON N are added into a water tank of an ultrasonic dispersion apparatus having an electric power of 120 W, Ultrasonic Dispersion System Tetora 150 (trade name, manufactured by Nikkaki Bios), containing two oscillators of 50 kHz in oscillation frequency with the phases shifted by 180°.

(4) The beaker in above (2) is set to a beaker securing hole of the ultrasonic dispersion system, and the ultrasonic dispersion system is started. Then, the height of the beaker is adjusted so that the resonance at the level of the aqueous electrolyte solution in the beaker can be largest.

(5) Into the beaker in above (4) with ultrasonic waves applied to the aqueous electrolyte solution, 10 mg of the toner (particles) is gradually added and dispersed. Such ultrasonic dispersion is further continued for 60 seconds. For the ultrasonic dispersion, the water temperature in the water tank is controlled to 10° C. to 40° C. as appropriate.

(6) The aqueous electrolyte solution in above (5), in which the toner (particles) is dispersed, is dropped with a pipette into the round bottom beaker in (1) set on the sample stand to adjust the measurement concentration to 5%. Then, the measurement is performed until the number of measured particles reaches 50000.

(7) The measurement data is analyzed with the dedicated software, and the weight average particle size (D4) is calculated. Here, “Average size” on the Analysis/Volume Statistic Value (Arithmetic Mean) screen (translation) in a state where graph/volume % is set in the software program represents the weight average particle size (D4). Also, “Average size” on the Analysis/Volume Statistic Value (Arithmetic Mean) screen (translation) in a state where graph/number % is set in the software program represents the number average particle size (D1).

### Measurement of Endothermic Peak Temperature of Toner

The highest endothermic peak temperature of the toner is measured according to ASTM D3418-82 with a differential scanning calorimeter “Q1000” (manufactured by TA Instruments).

The temperature correction of the detector of the calorimeter is performed using the melting points of indium and zinc, and the heat correction is performed using the heat of fusion of indium.

More specifically, about 10 mg of toner is weighed out and placed in an aluminum pan. The toner is measured in the temperature range of 30° C. to 200° C. at a heating rate of 10° C./min, using an empty aluminum pan as a reference. In this measurement, the sample is heated to 200° C. once, subsequently cooled to 30° C., and then heated again. The highest endothermic peak of the DSC curve in the second heating in the temperature range of 30° C. to 200° C. is defined as the highest endothermic peak in the DSC measurement of the toner disclosed herein.

### EXAMPLES

The present disclosure will be described in detail using the following Production Processes and Examples. However, these are not intended to limit the present disclosure. In the Production Processes and Examples, “part(s)” and “%” are on a mass basis unless otherwise specified.

### Synthesis of Polymerizable Compound A

### Polymerizable Compound A1

Polymerizable compound A1 was synthesized according to the following scheme.

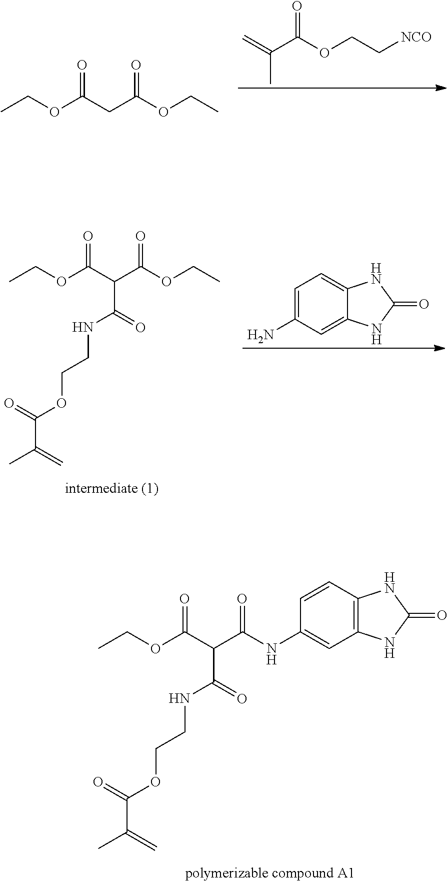

### Synthesis of Intermediate (1)

In 100 parts of xylene, 20.6 parts of diethyl malonate, 19.8 parts of 2-methacryloyloxyethyl isocyanate (“Karenz MOI” (trade name), produced by Showa Denko), and 0.284 part of 2,6-di-tert-butyl-p-cresol were dissolved, and the solution was heated to 60° C. After a reaction for 8 hours with the addition of 0.214 part of sodium methoxide, 200 parts of water was added to stop the reaction. The organic phase was extracted with toluene and concentrated. The resulting residue was crystallized with toluene to yield intermediate represented by the above formula (1).

### Synthesis of Polymerizable Compound A1

Then, 19.8 parts of interim (1), 11.4 parts of 5-amino-2-benzimidazolinone, 0.138 part of 2,6-di-tert-butyl-p-cresol were dissolved in 140 parts of N,N-dimethylformamide and heated at 80° C. for 6 hours with stirring for a reaction. After the reaction, N,N-dimethylformamide was removed under reduced pressure, and 300 parts of water was added to the resulting residue. The precipitate was filtered to obtain polymerizable compound A1 represented by the above formula.

### Polymerizable Compound A2

Polymerizable compound A2 was synthesized according to the following scheme.

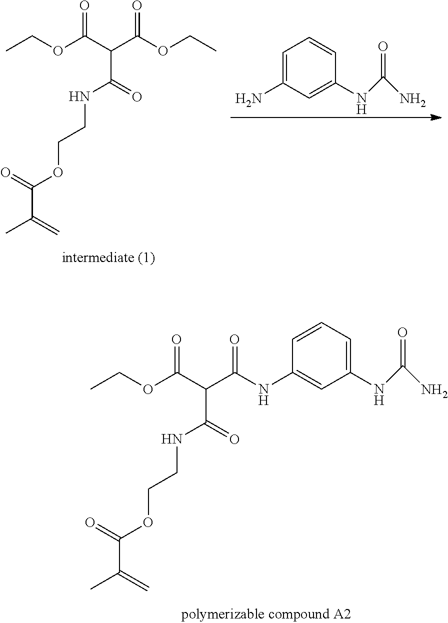 [SMILES: C=C(C)C(=O)OCCNC(=O)C(C(=O)OCC)C(=O)OCC ; NC(=O)Nc1cccc(N)c1 ; C=C(C)C(=O)OCCNC(=O)C(C(=O)Nc1cccc(NC(N)=O)c1)C(=O)OCC]

Polymerizable compound A2 was produced in the same manner as the above-describedpolymerizable compound A1, except that 5-amino-2-benzimidazolinone used in the synthesis of polymerizable compound A1 was replaced with 3-aminophenylureide.

### Polymerizable Compound A3

Polymerizable compound A3 was synthesized according to the following scheme.

### Synthesis of Intermediate (2)

To 11.0 parts of 4-aminophenol, 140 parts of dilute hydrochloric acid was added, and the solution was cooled to 5° C. or less. To this solution, 37.0 parts of 19.0% sodium nitrite aqueous solution was added dropwise while being cooled with ice to prepare a diazonium salt solution. Then, 237 parts of ethanol and 126.0 parts of 36.5% sodium acetate aqueous solution were added to 10.0 parts of acetylacetone, and the mixture was stirred and cooled to 5° C. or less. To the resulting solution, the diazonium salt solution prepared above was slowly added dropwise. The mixture was cooled with ice for 30 minutes and stirred at room temperature for 1 hour. The precipitate thus formed was filtered, rinsed with water, and dried to yield intermediate (2).

### Synthesis of Intermediate (3)

In 80.6 parts of methanol, 15.6 parts of intermediate (2) obtained above was dissolved, and 86.0 parts of 2 mol/L sodium hydroxide aqueous solution was further added, followed by cooling to 5° C. or less. The mixture of 30.5 parts of benzaldehyde and 20.5 parts of ethanol was added dropwise to the resulting solution, allowed to react for 3 hours with ice cooling, and then left to stand overnight in a refrigerator. Then, the reaction liquid was added to 500 parts of cold water and neutralized with acetic acid. The precipitate thus formed was collected and purified by silica gel column chromatography to yield intermediate (3).

### Synthesis of Polymerizable Compound A3

In 170 parts of pyridine, 14.4 parts of intermediate (3) obtained above were dissolved, and the solution was cooled to 5° C. or less. The solution prepared by dissolving 4.21 parts of methacryloyl chloride in 30.0 parts of pyridine was added dropwise to the above solution, followed by stirring for 1 hour. Then, 200 parts of water was added to stop the reaction. The reaction product was extracted with chloroform, rinsed with water, and concentrated to yield polymerizable compound A3 having the following structure.

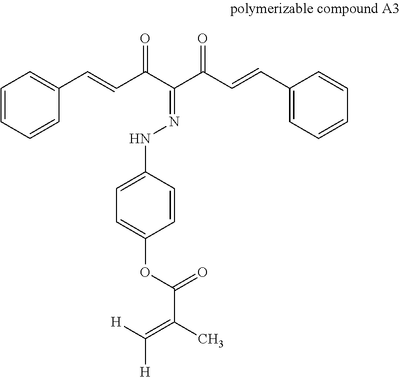 [SMILES: C=C(C)C(=O)Oc1ccc(NN=C(C(=O)/C=C/c2ccccc2)C(=O)/C=C/c2ccccc2)cc1]

### Synthesis of Polymerizable Ester Compounds

### Synthesis of Polymerizable Ester Compound 1

Into a pressure reaction vessel equipped with a stirrer, a temperature controller, a thermometer, an air inlet, a vacuum device, and a water-reducing unit, 980.0 parts of behenyl alcohol, 175.0 parts of fumaric acid, 2.5 parts of dibutyltin oxide, and 1.0 part of 2,6-di-tert-butyl-p-cresol were added, and the mixture was stirred at 120° C. to ensure uniformity. Then, the mixture was heated to 165° C. and subjected to esterification while the distillate was removed at 21 kPa for 3 hours and further esterification while the distillate was removed at 3 kPa or less for 12 hours.

The resulting product was taken out to obtain polymerizable ester compound 1.

### Synthesis of Polymerizable Ester Compounds 2 to 4

Polymerizable ester compounds 2 to 4 were synthesized in the same manner as polymerizable ester compound 1, except that the unsaturated polyvalent carboxylic acid and long-chain alkyl alcohol used in the synthesis of polymerizable ester compound 1 were replaced as presented in Table 1. The resulting polymerizable ester compounds had the structure represented by formula (2′).

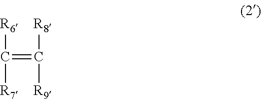

TABLE 1

| | unsaturated | Long- | | | | |
|---|---|---|---|---|---|---|
| | polyvalent | chain | | | | |
| Polymerizable ester | carboxylic | alkyl | Formula (2′) structure | | | |
| compound | acid | alcohol | R_{6′} | R₇ | R_{8′} | R_{9′} |
| Polymerizable ester | Fumaric acid | Behenyl | —COOC₂₂H₄₅ | H | H | —COOC₂₂H₄₅ |
| compound 1 | | alcohol | | | | |
| Polymerizable ester | Maleic acid | Cetanol | —COOC₁₆H₃₃ | H | —COOC₁₆H₃₃ | H |
| compound 2 | | | | | | |
| Polymerizable ester | Fumaric acid | Myricyl | —COOC₃₀H₆₁ | H | H | —COOC₃₀H₆₁ |
| compound 3 | | alcohol | | | | |
| Polymerizable ester | Fumaric acid | Lauryl | —COOC₁₂H₂₅ | H | H | —COOC₁₂H₂₅ |
| compound 4 | | alcohol | | | | |

### Synthesis of Pigment Dispersant

### Pigment Dispersant (Sy-1)

To a recovery flask purged with nitrogen are added the following:
Behenyl acrylate: 35.0 parts
Styrene: 14.0 parts
Polymerizable compound A1: 7.0 parts
Polymerizable ester compound 1: 30.0 parts
Azobisisobutyronitrile: 1.5 parts

The materials were stirred at 80° C. Polymerization was allowed to proceed while the molecular weight was monitored by GPC. As the molecular weight reached a desired value, the reaction was stopped by ice cooling to yield pigment dispersant (Sy-1).

### Pigment Dispersants (Sy-2 to Sy-15)

Pigment dispersants Sy-2 to Sy-15 were obtained in the same manner as pigment dispersant Sy-1, except that the composition in the production process of pigment dispersant Sy-1 was varied to the composition presented in Table 2.

TABLE 2

| | Pigment dispersant composition (mass %) | | | | | | | | | | |
|---|---|---|---|---|---|---|---|---|---|---|---|
| | Polymerizable | | Polymerizable ester | | Other monomer units | | | | | | Molecular |
| | compound | | compound | | Monomer 1 | | Monomer 2 | | Monomer 3 | | weight |
| | Type | mass % | Type | mass % | Type | mass % | Type | mass % | Type | mass % | Mw |
| Sy-1 | Polymerizable | 7.0 | Polymerizable | 30.0 | Styrene | 14.0 | MAN | 14.0 | BEA | 35.0 | 25000 |
| | compound A1 | | ester | | | | | | | | |
| | | | compound 1 | | | | | | | | |
| Sy-2 | Polymerizable | 12.0 | Polymerizable | 10.0 | Styrene | 38.0 | MAN | 10.0 | BEA | 30.0 | 39000 |
| | compound A1 | | ester | | | | | | | | |
| | | | compound 2 | | | | | | | | |
| Sy-3 | Polymerizable | 3.0 | Polymerizable | 60.0 | Styrene | 20.0 | MAN | 17.0 | — | — | 16000 |
| | compound A1 | | ester | | | | | | | | |
| | | | compound 3 | | | | | | | | |
| Sy-4 | Polymerizable | 1.5 | Polymerizable | 30.0 | Styrene | 48.5 | MAN | 20.0 | — | — | 26000 |
| | compound A1 | | ester | | | | | | | | |
| | | | compound 1 | | | | | | | | |
| Sy-5 | Polymerizable | 15.0 | Polymerizable | 30.0 | Styrene | 48.0 | MAN | 7.0 | — | — | 24000 |
| | compound A1 | | ester | | | | | | | | |
| | | | compound 1 | | | | | | | | |
| Sy-6 | Polymerizable | 1.0 | Polymerizable | 30.0 | Styrene | 49.0 | MAN | 20.0 | — | — | 25000 |
| | compound A1 | | ester | | | | | | | | |
| | | | compound 1 | | | | | | | | |
| Sy-7 | Polymerizable | 17.0 | Polymerizable | 30.0 | Styrene | 46.0 | MAN | 7.0 | — | — | 26000 |
| | compound A1 | | ester | | | | | | | | |
| | | | compound 1 | | | | | | | | |
| Sy-8 | Polymerizable | 7.0 | Polymerizable | 5.0 | Styrene | 9.0 | MAN | 14.0 | BEA | 65.0 | 24000 |
| | compound A1 | | ester | | | | | | | | |
| | | | compound 1 | | | | | | | | |
| Sy-9 | Polymerizable | 7.0 | Polymerizable | 70.0 | Styrene | 3.0 | MAN | 20.0 | — | — | 25000 |
| | compound A1 | | ester | | | | | | | | |
| | | | compound 1 | | | | | | | | |
| Sy-10 | Polymerizable | 7.0 | Polymerizable | 3.5 | Styrene | 10.5 | MAN | 14.0 | BEA | 65.0 | 26000 |
| | compound A1 | | ester | | | | | | | | |
| | | | compound 1 | | | | | | | | |
| Sy-11 | Polymerizable | 7.0 | Polymerizable | 80.0 | — | — | MAN | 13.0 | — | — | 24000 |
| | compound A1 | | ester | | | | | | | | |
| | | | compound 1 | | | | | | | | |
| Sy-12 | Polymerizable | 7.0 | Polymerizable | 30.0 | Styrene | 14.0 | MAN | 14.0 | BEA | 35.0 | 25000 |
| | compound A2 | | ester | | | | | | | | |
| | | | compound 1 | | | | | | | | |
| Sy-13 | Polymerizable | 7.0 | Polymerizable | 30.0 | Styrene | 14.0 | MAN | 14.0 | BEA | 35.0 | 26000 |
| | compound A1 | | ester | | | | | | | | |
| | | | compound 4 | | | | | | | | |
| Sy-14 | compound A1 | 7.0 | — | — | Styrene | 14.0 | MAN | 14.0 | BEA | 65.0 | 28000 |
| | Polymerizable | | | | | | | | | | |
| Sy-15 | Polymerizable | 7.0 | Polymerizable | 30.0 | Styrene | 14.0 | MAN | 14.0 | BEA | 35.0 | 27000 |
| | compound A3 | | ester | | | | | | | | |
| | | | compound 1 | | | | | | | | |

The abbreviations in Table 2 refer to the following:
MAN: methacrylonitrile
BEA: behenyl acrylate

### Synthesis of Crystalline Resin

### Crystalline Resin C1

To a reaction vessel equipped with a reflex condenser, a stirrer, a thermometer, and a nitrogen inlet were added the following:
Toluene: 100.0 parts
Behenyl acrylate: 80.0 parts
Styrene: 20.0 parts
Polymerization initiator, t-butylperoxypivalate (PERBUTYL PV, produced by NOF Corporation): 0.5 part

The contents in the reaction vessel were heated to 70° C. with stirring at 200 rpm and subjected to a polymerization reaction for 12 hours to yield a solution in which a polymer resulting from the polymer composition was dissolved. Then, toluene and residual monomers were removed at 160° C. and 1 hPa to yield crystalline resin C1. The resulting crystalline resin C1 had a weight average molecular weight Mw of 30000 and a melting point Tm of 60° C.

### Crystalline Resin C2

Into a reaction vessel equipped with a stirrer, a thermometer, a nitrogen inlet, a dehydration tube, and a vacuum device, 118.0 parts of sebacic acid and 69.0 parts of 1,6-hexanediol were added, and the mixture was heated to 130° C. with stirring. After adding 0.7 part of titanium (IV) isopropoxide as an esterification catalyst, the mixture was heated to 160° C. and subjected to condensation polymerization over 5 hours. Then, the temperature was raised to 180° C., and the reaction continued with depressurization until reaching a desired molecular weight, thus obtaining crystalline resin C2. The resulting crystalline resin C2 had a weight average molecular weight Mw of 28000 and a melting point Tm of 69° C.

### Crystalline Resin C3

To a reaction vessel equipped with a reflex condenser, a stirrer, a thermometer, and a nitrogen inlet were added the following:
Toluene: 100.0 parts
Polymerizable ester compound 1: 50.0 parts
Styrene: 50.0 parts
Polymerization initiator, t-butylperoxypivalate (PERBUTYL PV, produced by NOF Corporation): 0.5 part

The contents in the reaction vessel were heated to 70° C. with stirring at 200 rpm and subjected to a polymerization reaction for 12 hours to yield a solution in which a polymer resulting from the polymer composition was dissolved. Then, toluene and residual monomers were removed at 160° C. and 1 hPa to yield crystalline resin C3. The resulting crystalline resin C3 had a weight average molecular weight Mw of 32000 and a melting point Tm of 65° C.

### Production Process of Black Toner 1

### Preparation Step of Coloring Agent Dispersion Liquid 1

Styrene monomer: 100.0 parts
Carbon black (CB): 20.0 parts
   (Nipex 35, produced by Orion Engineered Carbons)
Pigment dispersant Sy-1 2.0 parts

These materials were added into an attritor (manufactured by Nippon Coke & Engineering) and stirred at 200 rpm for 180 minutes at 25° C. using 200 parts of zirconia beads with a radius of 2.5 mm to yield a coloring agent dispersion liquid 1.

### Preparation Step of Toner Composition-Dissolved Liquid

Coloring agent dispersion liquid 1: 41.8 parts
Styrene: 8.6 parts
n-Butyl acrylate (BA): 14.6 parts
Crystalline resin C1: 27.4 parts
Dipentaerythritol hexastearate: 7.7 parts

These materials were mixed and heated to 65° C. and dissolved or dispersed in each other at 5,000 rpm for 60 minutes using a TK homomixer (manufactured by PRIMIX Corporation) to yield toner composition-dissolved liquid 1.

### Preparation Step of Dispersion Liquid (Aqueous Medium)

Into a 2 L four-neck flask equipped with a high-speed stirrer, TK-homomixer, 710 parts of ion-exchanged water and 450 parts of 0.1 mol/L Na₃PO₄ aqueous solution were added, followed by heating to 60° C. Then, 67.7 parts of 1.0 mol/L CaCl₂ aqueous solution was slowly added to yield aqueous medium 1 containing calcium phosphate.

### Particle Formation Step

Toner composition-dissolved liquid 1 was added to aqueous medium 1 whose temperature was kept at 60° C. while the stirrer was kept at a rotational speed of 12500 rpm, and then 3.5 parts of t-butyl peroxypivalate was added as a polymerization initiator. The mixture was stirred for 10 minutes with the stirrer kept at 12500 rpm to form particles.

### Polymerization Step

The high-speed stirrer was replaced with another type with a propeller stirring blade, and polymerization was performed at 70° C. for 5.0 hours with stirring at 200 rpm. Then, residual monomers were removed by heating at 98° C. for 3.0 hours to yield black toner particle dispersion liquid 1 in which black toner particle was dispersed.

The resulting black toner particle dispersion liquid 1 was adjusted to a pH of 1.4 with hydrochloric acid and stirred for 1 hour to dissolve the calcium phosphate. The resulting liquid was subjected to solid-liquid separation under a pressure of 0.4 MPa in a pressure filtration device to yield toner cake 1. Then, ion-exchanged water was added to fill the pressure filtration device, and toner cake 1 was washed at a pressure of 0.4 MPa. This washing operation was repeated three times, and the toner cake was dried to yield black toner particle 1.

To 100.0 parts of the resulting black toner particle 1, 1.5 parts of hydrophobic silica fine powder (with a number average primary particle size of 10 nm) surface treated with hexamethyldisilazane was added and mixed for 300 s with a Henschel mixer (manufactured by Nippon Coke & Engineering) to yield black toner 1. The composition and physical properties of black toner 1 are presented in Tables 3-1 to 3-3.

### Production Process of Black Toners 2 to 28

Black toners 2 to 28 were produced in the same manner as black toner 1, except that the composition in the production process of black toner 1 was varied as presented in Tables 3-1 and 3-2. The compositions and physical properties of black toners 2 to 28 are presented in Tables 3-1 to 3-3.

TABLE 3-1

| | Toner particle composition | | | | | | | |
|---|---|---|---|---|---|---|---|---|
| | Binder resin | | Crystalline | | | | Pigment | |
| | Styrene | BA | resin | | Pigment | | dispersant | |
| | mass % | mass % | Type | mass % | Type | mass % | Type | mass % |
| Black toner 1 | 42.8 | 14.6 | C1 | 27.4 | CB | 6.8 | Sy-1 | 0.7 |
| Black toner 2 | 43.0 | 14.6 | C1 | 27.5 | CB | 6.9 | Sy-2 | 0.3 |
| Black toner 3 | 42.4 | 14.5 | C1 | 27.2 | CB | 6.8 | Sy-3 | 1.4 |
| Black toner 4 | 42.8 | 14.6 | C1 | 27.4 | CB | 6.8 | Sy-1 | 0.7 |
| Black toner 5 | 42.8 | 14.6 | C3 | 27.4 | CB | 6.8 | Sy-1 | 0.7 |
| Black toner 6 | 42.8 | 14.6 | C1 | 27.4 | CB | 6.8 | Sy-4 | 0.7 |
| Black toner 7 | 42.8 | 14.6 | C1 | 27.4 | CB | 6.8 | Sy-5 | 0.7 |
| Black toner 8 | 42.8 | 14.6 | C1 | 27.4 | CB | 6.8 | Sy-6 | 0.7 |
| Black toner 9 | 42.8 | 14.6 | C1 | 27.4 | CB | 6.8 | Sy-7 | 0.7 |
| Black toner 10 | 42.8 | 14.6 | C1 | 27.4 | CB | 6.8 | Sy-8 | 0.7 |
| Black toner 11 | 42.8 | 14.6 | C1 | 27.4 | CB | 6.8 | Sy-9 | 0.7 |
| Black toner 12 | 42.8 | 14.6 | C1 | 27.4 | CB | 6.8 | Sy-10 | 0.7 |
| Black toner 13 | 42.8 | 14.6 | C1 | 27.4 | CB | 6.8 | Sy-11 | 0.7 |
| Black toner 14 | 42.8 | 14.6 | C1 | 27.4 | CB | 6.8 | Sy-12 | 0.7 |
| Black toner 15 | 43.0 | 14.7 | C1 | 27.5 | CB | 6.9 | Sy-1 | 0.2 |
| Black toner 16 | 42.0 | 14.1 | C1 | 27.5 | CB | 6.8 | Sy-1 | 2.0 |
| Black toner 17 | 43.0 | 14.6 | C1 | 27.6 | CB | 6.9 | Sy-1 | 0.1 |
| Black toner 18 | 42.1 | 14.3 | C1 | 26.9 | CB | 6.7 | Sy-1 | 2.4 |
| Black toner 19 | 54.3 | 16.1 | C1 | 15.0 | CB | 6.9 | Sy-3 | 1.4 |
| Black toner 20 | 55.5 | 18.3 | C1 | 11.6 | CB | 6.9 | Sy-3 | 1.4 |
| Black toner 21 | 31.4 | 10.7 | C1 | 42.1 | CB | 6.9 | Sy-3 | 1.4 |
| Black toner 22 | 42.8 | 14.6 | C2 | 27.4 | CB | 6.8 | Sy-1 | 0.7 |
| Black toner 23 | 42.8 | 14.6 | — | — | CB | 6.8 | Sy-1 | 0.7 |
| Black toner 24 | 56.0 | 18.7 | — | — | CB | 6.7 | Sy-1 | 0.7 |
| Black toner 25 | 42.8 | 14.6 | C1 | 27.4 | CB | 6.8 | Sy-13 | 0.7 |
| Black toner 26 | 42.8 | 14.6 | C1 | 27.4 | CB | 6.8 | Sy-14 | 0.7 |
| Black toner 27 | 42.8 | 14.6 | C1 | 27.4 | CB | 6.8 | Sy-15 | 0.7 |
| Black toner 28 | 56.0 | 18.7 | — | — | CB | 6.7 | Sy-15 | 0.7 |

TABLE 3-2

| | Toner particle composition | | | |
|---|---|---|---|---|
| | Wax | | | |
| | Wax 1 | | Wax 2 | |
| | | mass | | mass |
| | Type | % | Type | % |
| Black toner 1 | Dipentaerythritol hexastearate | 7.7 | — | — |
| Black toner 2 | Dipentaerythritol hexastearate | 7.7 | — | — |
| Black toner 3 | Dipentaerythritol hexastearate | 7.7 | — | — |
| Black toner 4 | Hydrocarbon-based wax | 7.7 | — | — |
| | (FNP-90) | | | |
| Black toner 5 | Hydrocarbon-based wax | 7.7 | — | — |
| | (FNP-90) | | | |
| Black toner 6 | Dipentaerythritol hexastearate | 7.7 | — | — |
| Black toner 7 | Dipentaerythritol hexastearate | 7.7 | — | — |
| Black toner 8 | Dipentaerythritol hexastearate | 7.7 | — | — |
| Black toner 9 | Dipentaerythritol hexastearate | 7.7 | — | — |
| Black toner 10 | Dipentaerythritol hexastearate | 7.7 | — | — |
| Black toner 11 | Dipentaerythritol hexastearate | 7.7 | — | — |
| Black toner 12 | Dipentaerythritol hexastearate | 7.7 | — | — |
| Black toner 13 | Dipentaerythritol hexastearate | 7.7 | — | — |
| Black toner 14 | Dipentaerythritol hexastearate | 7.7 | — | — |
| Black toner 15 | Dipentaerythritol hexastearate | 7.7 | — | — |
| Black toner 16 | Dipentaerythritol hexastearate | 7.6 | — | — |
| Black toner 17 | Dipentaerythritol hexastearate | 7.8 | — | — |
| Black toner 18 | Dipentaerythritol hexastearate | 7.6 | — | — |
| Black toner 19 | Dipentaerythritol hexastearate | 6.3 | — | — |
| Black toner 20 | Dipentaerythritol hexastearate | 6.3 | — | — |
| Black toner 21 | Dipentaerythritol hexastearate | 7.5 | — | — |
| Black toner 22 | Dipentaerythritol hexastearate | 7.7 | — | — |
| Black toner 23 | Dipentaerythritol hexastearate | 7.7 | Stearyl | 27.4 |
| | | | stearate | |
| Black toner 24 | Dipentaerythritol hexastearate | 6.3 | Stearyl | 11.6 |
| | | | stearate | |
| Black toner 25 | Dipentaerythritol hexastearate | 7.7 | — | — |
| Black toner 26 | Dipentaerythritol hexastearate | 7.7 | — | — |
| Black toner 27 | Dipentaerythritol hexastearate | 7.7 | — | — |
| Black toner 28 | Dipentaerythritol hexastearate | 6.3 | Stearyl | 11.6 |
| | | | stearate | |

TABLE 3-3

| | Physical properties of toner | | |
|---|---|---|---|
| | Particle size (D4) | Molecular weight | Endothermic peak |
| | (μm) | Mw | temperature (° C.) |
| Black toner 1 | 6.9 | 58000 | 60 |
| Black toner 2 | 7.2 | 52000 | 60 |
| Black toner 3 | 7.1 | 55000 | 60 |
| Black toner 4 | 6.7 | 58000 | 60 |
| Black toner 5 | 6.6 | 56000 | 65 |
| Black toner 6 | 6.8 | 55000 | 60 |
| Black toner 7 | 6.9 | 57000 | 60 |
| Black toner 8 | 7.0 | 55000 | 60 |
| Black toner 9 | 6.9 | 54000 | 60 |
| Black toner 10 | 6.8 | 52000 | 60 |
| Black toner 11 | 6.8 | 53000 | 60 |
| Black toner 12 | 6.9 | 56000 | 60 |
| Black toner 13 | 7.1 | 57000 | 60 |
| Black toner 14 | 7.0 | 54000 | 60 |
| Black toner 15 | 6.8 | 55000 | 60 |
| Black toner 16 | 6.9 | 53000 | 60 |
| Black toner 17 | 6.9 | 56000 | 60 |
| Black toner 18 | 7.0 | 56000 | 60 |
| Black toner 19 | 7.0 | 54000 | 60 |
| Black toner 20 | 7.1 | 56000 | 60 |
| Black toner 21 | 6.8 | 55000 | 60 |
| Black toner 22 | 6.9 | 54000 | 69 |
| Black toner 23 | 6.8 | 56000 | 62 |
| Black toner 24 | 7.2 | 54000 | 62 |
| Black toner 25 | 6.9 | 55000 | 60 |
| Black toner 26 | 6.9 | 56000 | 60 |
| Black toner 27 | 6.9 | 56000 | 60 |
| Black toner 28 | 6.9 | 56000 | 62 |

### Production Process of Magenta Toner 1

### Preparation Step of Coloring Agent Dispersion Liquid 2

Styrene monomer: 100.0 parts
Pigment Red 122 (PR-122): 12.5 parts
   (Toner Magenta E, produced by Clariant)
Pigment Red 150 (PR-150): 7.5 parts
   (Fuji Fast Carmine 522, produced by Fuji Pigment Co., Ltd.)
Pigment dispersant Sy-1: 2.0 parts

These materials were added into an attritor (manufactured by Nippon Coke & Engineering) and stirred at 200 rpm for 180 minutes at 25° C. using 200 parts of zirconia beads with a radius of 2.5 mm to yield a coloring agent dispersion liquid 2.

The subsequent operations were conducted in the same manner as in the production process of black toner 1 to produce magenta toner 1, except for using coloring agent dispersion liquid 2. The composition and physical properties of the resulting magenta toner 1 are presented in Tables 4-1 and 4-2.

### Production Process of Magenta Toners 2 and 3

Magenta toners 2 and 3 were produced in the same manner as in the production process of magenta toner 1, except that the composition was varied as presented in Table 4-1. The composition and physical properties of magenta toners 2 and 3 are presented in Tables 4-1 and 4-2.

TABLE 4-1

| | Toner particle composition | | | | | | | | | | | |
|---|---|---|---|---|---|---|---|---|---|---|---|---|
| | Binder resin | | | | | | | | | | | |
| | | | Crystalline | | Pigment | | | | Pigment | | | |
| | Styrene | BA | resin | | Pigment 1 | | Pigment 2 | | dispersant | | Wax | |
| | mass % | mass % | Type | mass % | Type | mass % | Type | mass % | Type | mass % | Type | mass % |
| Magenta | 42.6 | 14.5 | C1 | 27.2 | PR122 | 4.6 | PR150 | 2.7 | Sy-1 | 0.7 | Dipentaerythritol | 7.7 |
| toner 1 | | | | | | | | | | | hexastearate | |
| Magenta | 42.8 | 14.5 | C1 | 27.4 | PR122 | 4.6 | PR150 | 2.7 | Sy-2 | 0.3 | Dipentaerythritol | 7.7 |
| toner 2 | | | | | | | | | | | hexastearate | |
| Magenta | 42.4 | 14.3 | C1 | 27.0 | PR122 | 4.6 | PR150 | 2.7 | Sy-3 | 1.4 | Dipentaerythritol | 7.6 |
| toner 3 | | | | | | | | | | | hexastearate | |

TABLE 4-2

| | Physical properties of toner | | |
|---|---|---|---|
| | Particle size (D4) | Molecular weight | Endothermic peak |
| | (μm) | Mw | temperature (° C.) |
| Magenta toner1 | 7.2 | 62000 | 60 |
| Magenta toner2 | 7.3 | 67000 | 60 |
| Magenta toner3 | 6.9 | 65000 | 60 |

### Preparation Process of Yellow Toner 1

### Preparation Step of Coloring Agent Dispersion Liquid 3

Styrene monomer: 100.0 parts
Pigment Yellow 155 (PY-155): 20.0 parts
   (Paliotol Yellow D1155, produced by BASF)
Pigment dispersant Sy-1: 2.0 parts

These materials were added into an attritor (manufactured by Nippon Coke & Engineering) and stirred at 200 rpm for 180 minutes at 25° C. using 200 parts of zirconia beads with a radius of 2.5 mm to yield a coloring agent dispersion liquid 3.

The subsequent operations were conducted in the same manner as in the production process of black toner 1 to produce yellow toner 1, except for using coloring agent dispersion liquid 3. The composition and physical properties of the resulting yellow toner 1 are presented in Tables 5-1 and 5-2.

### Preparation Process of Yellow Toners 2 to 7

Yellow toners 2 to 7 were produced in the same manner as in the production process of yellow toner 1, except that the composition was varied as presented in Table 5-1. The composition and physical properties of yellow toners 2 to 7 are presented in Tables 5-1 and 5-2.

TABLE 5-1

| | Toner particle composition | | | | | | | | | |
|---|---|---|---|---|---|---|---|---|---|---|
| | Binder resin | | | | | | | | | |
| | | | Crystalline | | | | Pigment | | | |
| | Styrene | BA | resin | | Pigment | | dispersant | | Wax | |
| | mass % | mass % | Type | mass % | Type | mass % | Type | mass % | Type | mass % |
| Yellow | 42.8 | 14.6 | C1 | 27.4 | PY155 | 6.8 | Sy-1 | 0.7 | Dipentaerythritol | 7.7 |
| toner 1 | | | | | | | | | hexastearate | |
| Yellow | 43.0 | 14.6 | C1 | 27.5 | PY155 | 6.9 | Sy-2 | 0.3 | Dipentaerythritol | 7.7 |
| toner 2 | | | | | | | | | hexastearate | |
| Yellow | 42.5 | 14.5 | C1 | 27.2 | PY155 | 6.8 | Sy-3 | 1.4 | Dipentaerythritol | 7.6 |
| toner 3 | | | | | | | | | hexastearate | |
| Yellow | 42.8 | 14.6 | C1 | 27.4 | PY74 | 6.8 | Sy-1 | 0.7 | Dipentaerythritol | 7.7 |
| toner 4 | | | | | | | | | hexastearate | |
| Yellow | 42.8 | 14.6 | C1 | 27.4 | PY93 | 6.8 | Sy-1 | 0.7 | Dipentaerythritol | 7.7 |
| toner 5 | | | | | | | | | hexastearate | |
| Yellow | 42.8 | 14.6 | C1 | 27.4 | PY180 | 6.8 | Sy-1 | 0.7 | Dipentaerythritol | 7.7 |
| toner 6 | | | | | | | | | hexastearate | |
| Yellow | 42.8 | 14.6 | C1 | 27.4 | PY185 | 6.8 | Sy-1 | 0.7 | Dipentaerythritol | 7.7 |
| toner 7 | | | | | | | | | hexastearate | |

TABLE 5-2

| | Physical properties of toner | | |
|---|---|---|---|
| | Particle size (D4) | Molecular weight | Endothermic peak |
| | (μm) | Mw | temperature (° C.) |
| Yellow toner 1 | 7.1 | 62000 | 60 |
| Yellow toner 2 | 6.9 | 65000 | 60 |
| Yellow toner 3 | 6.8 | 63000 | 60 |
| Yellow toner 4 | 7.0 | 61000 | 60 |
| Yellow toner 5 | 7.1 | 62000 | 60 |
| Yellow toner 6 | 6.9 | 63000 | 60 |
| Yellow toner 7 | 7.2 | 64000 | 60 |

### Production Process of Cyan Toner 1

### Preparation Step of Coloring Agent Dispersion Liquid 4

Styrene monomer: 100.0 parts
Pigment Blue 15:3: 20.0 parts
   (ECB-308, manufactured by Dainichiseika Color & Chemicals Mfg.)
Pigment dispersant Sy-1: 2.0 parts

These materials were added into an attritor (manufactured by Nippon Coke & Engineering) and stirred at 200 rpm for 180 minutes at 25° C. using 200 parts of zirconia beads with a radius of 2.5 mm to yield a coloring agent dispersion liquid 4.

The subsequent operations were conducted in the same manner as in the production process of black toner 1 to produce cyan toner 1, except for using coloring agent dispersion liquid 4. The composition and physical properties of the resulting cyan toner 1 are presented in Tables 6-1 and 6-2.

### Production Process of Cyan Toners 2 and 3

Cyan toners 2 and 3 were produced in the same manner as in the production process of cyan toner 1, except that the composition was varied as presented in Table 6-1. The composition and physical properties of cyan toners 2 and 3 are presented in Tables 6-1 and 6-2.

TABLE 6-1

| | Toner particle composition | | | | | | | | | |
|---|---|---|---|---|---|---|---|---|---|---|
| | Binder resin | | | | | | | | | |
| | | | Crystalline | | | | Pigment | | | |
| | Styrene | BA | resin | | Pigment | | dispersant | | Wax | |
| | mass % | mass % | Type | mass % | Type | mass % | Type | mass % | Type | mass % |
| Cyan | 42.8 | 14.6 | C1 | 27.4 | PB15:3 | 6.8 | Sy-1 | 0.7 | Dipentaerythritol | 7.7 |
| toner 1 | | | | | | | | | hexastearate | |
| Cyan | 43.0 | 14.6 | C1 | 27.5 | PB15:3 | 6.9 | Sy-2 | 0.3 | Dipentaerythritol | 7.7 |
| toner 2 | | | | | | | | | hexastearate | |
| Cyan | 42.5 | 14.5 | C1 | 27.2 | PB15:3 | 6.8 | Sy-3 | 1.4 | Dipentaerythritol | 7.6 |
| toner 3 | | | | | | | | | hexastearate | |

TABLE 6-2

| | Physical properties of toner | | |
|---|---|---|---|
| | Particle size (D4) | Molecular weight | Endothermic peak |
| | (μm) | Mw | temperature (° C.) |
| Cyan toner 1 | 7.0 | 59000 | 60 |
| Cyan toner 2 | 7.1 | 60000 | 60 |
| Cyan toner 3 | 6.9 | 61000 | 60 |

### Evaluation

For evaluation, a commercially available color laser printer (HP LaserJet Enterprise Color M555 dn) was partially modified so that: the printer would work even if only one color process cartridge were installed; and the temperature of the fuser could be varied as desired.

The process cartridges were all removed from the printer. The toner contained in the black toner process cartridge was removed, and the inside of the cartridge was cleaned by air blowing. Then, a toner (250 g) to be evaluated was introduced into the process cartridge. Only this black toner cartridge, in which the toner had been replaced, was installed in the printer for the following evaluations. The toner was evaluated as follows.

### Evaluation of Toner Tinting Strength

A 6.5 cm×14.0 cm rectangular solid image (toner deposition rate: 0.45 mg/cm²) was output in the center of the transfer medium and used for evaluation. The image density of the evaluation image was measured to evaluate the tinting strength. A color reflection densitometer X-Rite 404A was used to measure the image density. The density was measured at 5 points: the upper right, upper left, center, lower right, and lower left of the solid image, and the average of these measurements was evaluated as the image density. The transfer medium used was LETTER-sized glossy paper (HP Brochure Paper 150 g, Glossy).

### Criteria:

A: The image density was 1.70 or more.
B: The image density was 1.65 to less than 1.70.
C: The image density was 1.60 to less than 1.65.
D: D: The image density was less than 1.60.

### Evaluation of Color Unevenness

A solid image (toner deposition rate: 0.45 mg/cm²) was fixed to a transfer medium at a fixing temperature of 200° C. to obtain a printed image. The printed image was left in a high-temperature, high-humidity environment (32° C./85% RH) for one month. Then, the solid image was divided into 15 areas (5 areas in the longitudinal direction, 3 areas in the transverse direction), and the gloss value of the center of each area was measured with PG-3D (manufactured by Nippon Denshoku Industries). For the gloss values at the 15 points, the difference between the average and the largest and the difference between the average and the smallest were calculated. The larger value of the absolute values of the calculated differences was used to calculate the percentage (%) of the difference from the average, and the color unevenness was evaluated according to the following criteria. The transfer medium used was LETTER-sized glossy paper (HP Brochure Paper 150 g, Glossy).

### Criteria:

A: 3.0% or less
B: 3.1% to less than 5.0%
C: 5.1% to less than 10.0%
D: 10.1% or more

### Evaluation of Low-Temperature Fixability

An unfixed image of a solid image (toner deposition rate: 0.45 mg/cm²) was formed on a transfer medium and subjected to a fixing test by varying the fixing temperature in increments of 5° C. from 115° C. The density of the resulting fixed image was measured, and the measured area was rubbed five times at a load of 50 g/cm² with Silbon paper (Lenz Cleaning Paper “dasper (R)” manufactured by Ozu Paper Co. Ltd.) The temperature at which the percentage of density decrease before and after rubbing was 10% or less was taken as the start temperature for fixing. The fixing temperature was the surface temperature of the fixing roller measured with a non-contact thermometer. The transfer medium used was LETTER-sized plain paper (Vitality, manufactured by XEROX, 75 g/m²).

### Criteria:

A: Start temperature for fixing was 115° C.
B: Start temperature for fixing was 120° C. to 130° C.
C: Start temperature for fixing was 135° C. to 145° C.
D: Start temperature for fixing was 150° C. or more.

### Evaluation of Streaks (Developability)

An image with 1% print coverage of horizontal lines was printed on 30000 sheets of paper in a high-temperature, high-humidity environment (32° C./85% RH), and then a half-tone image (toner deposition rate: 0.25 mg/cm²) was printed on a LETTER-sized plain paper (Vitality, manufactured by XEROX, 75 g/m²). The half-tone image was checked for vertical streaks in the paper ejecting direction, and the developability was evaluated as presented below.

### Criteria:

A: No streaks
B: Vertical streaks occurred in 1 to 3 areas.
C: Vertical streaks occurred in 4 to 6 areas.
D: Vertical streaks occurred in 7 or more areas, or vertical streaks with a width of 0.5 mm or more occurred.

### Evaluation of Storage Stability (Heat Resistance)

Each of the toners, weighing 5 g, was placed in a 50 mL resin cup and left at 60° C. and 10% RH for three days. Then, the toner was checked for aggregation and evaluated according to the following criteria:

### Criteria:

A: No aggregation occurred.
B: Minor aggregation occurred, which crumbled when pressed lightly with a finger.
C: Aggregation occurred, which did not crumble even when pressed lightly with a finger.
D: Aggregation occurred and did not crumble.

### Examples 1 to 24

In Examples 1 to 24, black toners 1 to 24 were subjected to the above evaluations. The results are presented in Table 7.

### Comparative Examples 1 to 4

In Comparative Examples 1 to 4, black toners 25 to 28 were subjected to the above evaluations. The results are presented in Table 7.

TABLE 7

| | | | | | | | | Storage |
|---|---|---|---|---|---|---|---|---|
| | | | | | Low- | | | stability |
| | | Tinting | | Color | temperature | | Streaks | (Heat |
| | | strength | | Unevenness | fixability | | (Developability) | resistance) |
| Example 1 | Black toner 1 | A | 1.78 | A | A | 110 | A | A |
| Example 2 | Black toner 2 | A | 1.72 | A | A | 115 | A | A |
| Example 3 | Black toner 3 | A | 1.75 | A | A | 110 | A | A |
| Example 4 | Black toner 4 | A | 1.76 | A | A | 110 | A | A |
| Example 5 | Black toner 5 | A | 1.76 | A | A | 110 | A | A |
| Example 6 | Black toner 6 | B | 1.77 | A | A | 110 | A | A |
| Example 7 | Black toner 7 | B | 1.68 | A | A | 110 | A | A |
| Example 8 | Black toner 8 | C | 1.61 | A | A | 110 | A | A |
| Example 9 | Black toner 9 | C | 1.63 | A | A | 110 | A | A |
| Example 10 | Black toner 10 | B | 1.69 | B | A | 110 | A | A |
| Example 11 | Black toner 11 | B | 1.68 | A | A | 110 | A | A |
| Example 12 | Black toner 12 | C | 1.62 | C | A | 110 | A | A |
| Example 13 | Black toner 13 | C | 1.63 | A | A | 110 | A | A |
| Example 14 | Black toner 14 | B | 1.65 | A | A | 110 | A | A |
| Example 15 | Black toner 15 | B | 1.66 | B | A | 110 | A | A |
| Example 16 | Black toner 16 | B | 1.68 | A | A | 110 | A | A |
| Example 17 | Black toner 17 | C | 1.62 | C | A | 110 | A | A |
| Example 18 | Black toner 18 | C | 1.64 | A | A | 110 | A | A |
| Example 19 | Black toner 19 | A | 1.77 | A | B | 120 | A | A |
| Example 20 | Black toner 20 | A | 1.79 | A | B | 130 | A | B |
| Example 21 | Black toner 21 | A | 1.70 | A | A | 105 | A | B |
| Example 22 | Black toner 22 | A | 1.78 | A | B | 125 | B | B |
| Example 23 | Black toner 23 | A | 1.74 | A | B | 130 | C | B |
| Example 24 | Black toner 24 | A | 1.72 | A | C | 140 | B | A |
| Comparative | Black toner 25 | D | 1.58 | C | A | 115 | B | D |
| Example 1 | | | | | | | | |
| Comparative | Black toner 26 | D | 1.56 | D | A | 115 | A | A |
| Example 2 | | | | | | | | |
| Comparative | Black toner 27 | D | 1.55 | A | A | 115 | A | A |
| Example 3 | | | | | | | | |
| Comparative | Black toner 28 | D | 1.55 | A | C | 140 | B | A |
| Example 4 | | | | | | | | |

### Examples 25 to 37

In Examples 25 to 27, magenta toners 1 to 3 were subjected to the above evaluations. In Examples 28 to 34, yellow toners 1 to 7 were subjected to the above evaluations. In Examples 35 to 37, cyan toners 1 to 3 were subjected to the above evaluations. The results are presented in Table 8.

TABLE 8

| | | | | | | | | Storage |
|---|---|---|---|---|---|---|---|---|
| | | | | | Low- | | | stability |
| | | Tinting | | Color | temperature | | Streaks | (Heat |
| | | strength | | Unevenness | fixability | | (Developability) | resistance) |
| Example 25 | Magenta | A | 1.75 | A | A | 110 | A | A |
| | toner1 | | | | | | | |
| Example 26 | Magenta | A | 1.70 | A | A | 115 | A | A |
| | toner2 | | | | | | | |
| Example 27 | Magenta | A | 1.73 | A | A | 115 | A | A |
| | toner3 | | | | | | | |
| Example 28 | Yellow | A | 1.75 | A | A | 110 | A | A |
| | toner 1 | | | | | | | |
| Example 29 | Yellow | A | 1.77 | A | A | 110 | A | A |
| | toner 2 | | | | | | | |
| Example 30 | Yellow | A | 1.73 | A | A | 110 | A | A |
| | toner 3 | | | | | | | |
| Example 31 | Yellow | A | 1.76 | A | A | 110 | A | A |
| | toner 4 | | | | | | | |
| Example 32 | Yellow | A | 1.74 | A | A | 110 | A | A |
| | toner 5 | | | | | | | |
| Example 33 | Yellow | A | 1.80 | A | A | 110 | A | A |
| | toner 6 | | | | | | | |
| Example 34 | Yellow | A | 1.81 | A | A | 110 | A | A |
| | toner 7 | | | | | | | |
| Example 35 | Cyan | A | 1.73 | A | A | 110 | A | A |
| | toner 1 | | | | | | | |
| Example 36 | Cyan | A | 1.71 | A | A | 115 | A | A |
| | toner 2 | | | | | | | |
| Example 37 | Cyan | A | 1.73 | A | A | 115 | A | A |
| | toner 3 | | | | | | | |

The present disclosure can provide a toner with high tinting strength.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-097874 filed Jun. 18, 2024, which is hereby incorporated by reference herein in its entirety.

What is claimed is:

1. A toner comprising:
a toner particle containing a binder resin, a pigment, and a pigment dispersant,
the pigment dispersant comprising a structure represented by formula (1) and a structure represented by formula (2): 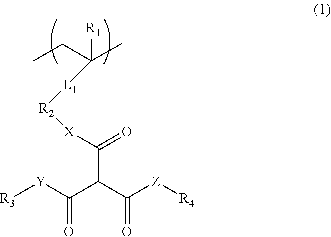
wherein in formula (1),
X, Y, and Z each independently represent —O—, a methylene group, or —NR₅—,
R₅ represents a hydrogen atom or an alkyl group with 1 to 4 carbon atoms,
L₁ represents an ester bond or an amide bond,
R₁ represents a hydrogen atom or a methyl group,
R₂ represents an alkylene group with 2 to 4 carbon atoms,
R₄ represents a substituted or unsubstituted phenyl group, a substituted or unsubstituted polycyclic aromatic group, or a substituted or unsubstituted heterocyclic group, and
R₃ represents a hydrogen atom, a substituted or unsubstituted phenyl group, an aralkyl group, a substituted or unsubstituted alkyl group with 1 to 18 carbon atoms, or a monovalent group formed by substituting —O—, —COO—, or —CONH— for a methylene group of an alkyl group with 2 to 18 carbon atoms, 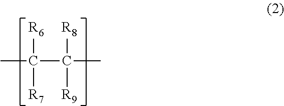
wherein in formula (2),
at least two of R₆ to R₉ represent —V—COOR₁₀ and the others each independently represent a hydrogen atom or an alkyl group with 1 to 4 carbon atoms,
V represents a single bond or an alkylene group with 1 or 2 carbon atoms, and
R₁₀ represents an alkyl group with 16 to 30 carbon atoms.

2. The toner according to claim 1, wherein the amount of the structure represented by formula (1) in the pigment dispersant is 1.0 mass % to 15.0 mass %.

3. The toner according to claim 1, wherein the amount of the structure represented by formula (2) in the pigment dispersant is 5.0 mass % to 70.0 mass %.

4. The toner according to claim 1, wherein the structure represented by formula (1) is represented by formula (3): 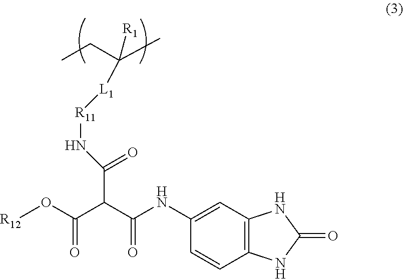
wherein in formula (3),
L₁ represents an ester bond or an amide bond,
R₁ represents a hydrogen atom or a methyl group,
R₁₁ represents an alkylene group with 2 to 4 carbon atoms, and
R₁₂ represents a hydrogen atom, a substituted or unsubstituted phenyl group, an aralkyl group, a substituted or unsubstituted alkyl group with 1 to 18 carbon atoms, or a monovalent group formed by substituting —O—, —COO—, or —CONH— for a methylene group of an alkyl group with 2 to 18 carbon atoms.

5. The toner according to claim 1, wherein the amount of the pigment dispersant in the toner particle is 1.5 mass % to 30.0 mass % relative to the total mass of the pigment.

6. The toner according to claim 1, wherein the pigment is at least one selected from the group consisting of:
carbon black; C.I. Pigment Yellow 74, 93, 139, 155, 180, and 185; C.I. Pigment Red 31, 122, 150, 170, 258, and 269; and C.I. Pigment Blue 15:3 and 15:4.

7. The toner according to claim 1, wherein the toner particle contains a crystalline material.

8. The toner according to claim 7, wherein the amount of the crystalline material in the toner particle is 20.0 mass % to 50.0 mass % relative to the mass of the toner particle.

9. The toner according to claim 7, wherein the crystalline material is a crystalline resin.

10. The toner according to claim 9, wherein the crystalline resin is a crystalline vinyl resin having a structure represented by formula (4) or a crystalline vinyl resin having a structure represented by formula (5): 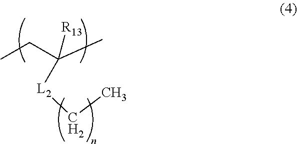
wherein in formula (4),
R₁₃ represents a hydrogen atom or a methyl group,
L₂ represents a single bond, —COO—, or —CONH—, and
n represents an integer of 15 to 30, 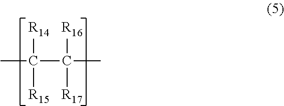
wherein in formula (5),
at least two of R₁₄ to R₁₇ represent —W—COOR₁₈ and the others each represent a hydrogen atom or an alkyl group with 1 to 4 carbon atoms,
W represents a single bond or an alkylene group with 1 or 2 carbon atoms, and
R₁₈ represents an alkyl group with 16 to 30 carbon atoms.
